(19) United States
(12) Patent Application Publication
(10) Pub. No.: US 2005/0027606 A1
(43) Pub. Date: Feb. 3, 2005

(54) Systems and methods for consumers to purchase health care and related products

(76) Inventor: Mark Pearson, Los Gatos, CA (US)

Correspondence Address: HELLER EHRMAN WHITE & MCAULIFFE LLP, 275 MIDDLEFIELD ROAD, MENLO PARK, CA, 94025-3506, US

(21) Appl. No.: 10/668,689

(22) Filed: Sep. 22, 2003

Related U.S. Application Data
(60) Provisional application No. 60/491,205, filed on Jul. 29, 2003.

(51) Int. Cl. G06F 17/60

(52) U.S. Cl. 705/26; 705/2

(57) ABSTRACT

A method of selling a health related product or service via the Internet provides a service provider system that includes a web server. The service provider system has members that purchase health related products and services through the service provider system. Applicants are enrolled in the service provider system as members. A product or service request message is received for a desired product or service from a member through a customer interface. The product or service request message includes a product or service identifier. The service provider system transmits a request for the desired product or service request to a supplier of the desired product or service. Points are recorded within a computer memory awarded to a member for purchases made by the member through the service provider system.

### CROSS-REFERENCE TO RELATED APPLICATION

This applications claims the benefit of 60/491,205 filed Jul. 29, 2003, which application is fully incorporated herein by reference.

### FIELD OF THE INVENTION

The present invention is directed to methods and systems directed to medical care and health insurance, and more particularly to, methods and systems for consumers to reduce or eliminate the cost of obtaining high quality medical care and health insurance by purchasing for their own use such care products and insurance for themselves as well as making recommendations to third parties for the acquisition of the same.

### DESCRIPTION OF THE RELATED ART

There are currently more than 41 million Americans who are uninsured. Most of the 41 million are younger workers who are unaware that their expenditures for health care through physicians and hospitals exceeds that paid by insurance companies for the same service. In 2002, only 62% of businesses that employ 10-49 people offered a health plan. In 2001, the number was 66%. Approximately 60% of the 41 million Americans who lack medical insurance are members of families that either own or work for small businesses. Small companies that sign with a new insurance carrier undergo extensive healthcare underwriting and pay more in premiums than larger companies. Additionally, the average health insurance premiums rose 14.8% to $4,564 per employee in 2002.

In 1986, the Consolidation Omnibus Reconciliation Act (COBRA) was enacted and mandated that terminated employees are allowed to purchase health insurance from their former employer for up to 18 months after termination. However, the cost of the continued insurance benefits is fairly high, and few terminated employees can afford the insurance, especially without the income tax advantages of employer paid insurance. Only 21% elect to purchase COBRA

From 1965-2002 the costs of health care costs grew from 5% to 14.7% of GDP. It is estimated that lifestyle behaviors alone contribute to 50% of an individual's health status. Today, there are less employers that offer insurance, and for those that do provide health insurance the costs to the employees have increased. As a consequence, consumers are taking more of the financial risks associated with health care.

It is anticipated that in ten years, employers will be paying a smaller share of overall health care costs and employees will be paying more. In 2002 PPO enrollment jumped to 52% of all covered workers up from 28% in 1996, and enrollment in HMOs fell to 26% from 31% in 1996. The White House proposed spending $89 billion in new tax credits over 10 years to help low income people buy health coverage, congress has set aside $50 billion in its, budget.Congress has proposed and passed the H.R. 2596, the Health Savings& Affordability Act of 2003, passed by a vote of 237-191. (Jun. 26, 2003), which provides for Health Savings Accounts (HAS): The annual contribution limit is 100% of the deductible under the health plan. This may be between $1,000-$2,500 (self coverage policies) and $3,350-$6,150 (family policies). Also proposed are Health Savings Security Accounts (HSSA). Individuals with self coverage policies—annual contributions limit is $2,000. Family coverage policies and uninsured individuals with dependents, the annual limit is $4,000.

Direct selling/network marketing organizations market and sell products or services by independent salespeople (person-to-person). More than 43 million people participate in direct selling worldwide. 83% of all direct sellers operate their businesses part-time. Direct selling/network marketing is a rapidly growing industry with U.S. sales of $26.69 billion in 2001. The percentage of American adults who are interested in using the internet as a method of purchasing products and services has increased from 30% of American adults reported in 1997 to 50%

There is a need for improved methods and systems for selling heal related products, service and health care insurance plans through the internet. There is a further need for methods and systems for selling health related products, services and health care insurance plans over the internet where the consumer can benefit from their own purchase and purchased made by others, such that a system is created that tracks points awarded by a service provider system to its members for purchases made through the service provider system.

### SUMMARY OF THE INVENTION

Accordingly, an object of the present invention is to provide methods and systems for selling health related products, services and health care insurance plans through the internet.

Yet another object of the present invention is to provide methods for

selling health related products and services over the internet through a service provider system that awards points to its member for purchases made by the member himself as well as for those purchases made by members who were referred to the service provider system by the member.

A further object of the present invention is to provide methods for selling health related products and services over the internet through a service provider system that awards debit and or credit cards to its members for purchases.

Another object of the present invention is to provide methods for brokering health savings, health savings security accounts and other similar types of approved health accounts.

Yet another object of the present invention is to provide methods for purchasing health related products and services through the internet through a service provider system that awards points for purchase made, where at least a portion or all of the awarded points are not treated as taxable income for federal income tax purposes at they time they are awarded or used.

A further object of the present invention is to provide methods for brokering health care insurance plans and other health-related insurance plans to members of a service provider system through the internet.

These and other objects of the present invention are achieved in a method for selling health related products or services via the Internet. A service provider system is provided that includes a web server. Applicants are enrolled in the service provider system as members. The service provider system records in a computer memory points awarded to a member for purchases, (i) made by the member itself through the service provider system, (ii) made by members who were referred to the service provider system by the member, and (iii) made by members who were referred to the service provider system by members in (ii). A member identifier is assigned to each member and recorded in a computer memory. A request message from a purchasing member is received at the service provider system that contains a requested product or service item identifier and a purchasing member identifier. The service provider system transmits to a supplier of the requested product or service, a request for the product or service.

In another embodiment of the present invention, a method of brokering health care insurance plans via the Internet is provided. A service provider system is provided with a web server that has a health care insurance plan database. The service provider system has members that purchase health care insurance plans through the service provider system. Applicants are enrolled in the service provider system as members. A member is assigned identifier that is stored in a computer memory. A computer memory stores points awarded to a member for purchases, (i) made by the member itself through the service provider system, (ii) made by members who were referred to the service provider system by the member, and (iii) made by members who were referred to the service provider system by members in (ii). A member can utilize points awarded under (i) to offset the costs associated with a health care insurance plan through the service provider system. The service provider system receives, from a member purchasing a health care insurance plan, a request message that contains a requested health care insurance plan identifier and a purchasing member identifier. The service provider system transmits to a supplier of the health care insurance plan, a request for approval of the member for the health care insurance plan.

In another embodiment of the present invention, a method of brokering health care insurance plans via the Internet is provided. A service provider system is provided with a web server that has a database of health care products, services and health care insurance plan database. The service provider system has members that purchase health care products, services and plans through the service provider system. At least a portion of the health care insurance plans are defined health care insurance plans that are least partially funded by tax-free dollars. Applicants are enrolled in the service provider system as members. A member identifier is assigned to a member that is stored in a computer memory. The service provider system receives from a member, after the member has become enrolled in the service provider system, a request for information on one or more health care insurance plans. A health care insurance plan is selected by the member through the service provider system. The service provider system transmits to a supplier of the health care insurance plan, a request for approval of the member for the health care insurance plan selected by the member.

In another embodiment of the present invention, a method is provided for brokering health care insurance plans via the Internet. A service provider system has a web server with a database of health care products, services and health care insurance plan database. The service provider system has members that purchase health care products, services and plans through the service provider system. Applicants are enrolled in the service provider system as members. The service provider system receives from members requests for information on one or more health care insurance plans. Health care insurance plans are selected by members through the service provider system. All or at least a portion of the health care insurance plans are defined health care insurance plans that are least partially funded by tax-free dollars. A plurality of different purchases by members of health care insurance plans are aggregated together by the service provider system to effect a decreased cost of at least a portion of the health care insurance plans. The service provider system transmits, to suppliers of the health care insurance plans, requests for approval of members for the health care insurance plans selected by the members.

In another embodiment of the present invention, a method of brokering health care insurance plan via the Internet provides a service provider system with a web server that has a database of health care products, services and a health care insurance plans database. The service provider system has members that purchase health care products, services and plans as a community through the service provider system. Applicants are enrolled in the service provider system as members. A member is assigned a member identifier that is stored in a computer memory. The service provider system receives from a member a request for information on one or more health care insurance plan. A health care insurance plan is selected by the member through the service provider system. The service provider system transmits to a supplier of the health care insurance plan, a request for approval of the member for the health care insurance plan selected by the member. The health care insurance plan is purchased through the service provider system.

### BRIEF DESCRIPTION OF THE DRAWINGS

FIG. 1 is schematic block diagram illustrating one embodiment of a service provider system of the present invention.

FIG. 2 is a flow chart illustrating one embodiment of the present invention where the purchasing power of members is aggregated in the community of service provider system from FIG. 1, and points are awarded for purchases made through the service provider system.

FIG. 3 is a flow chart illustrating an embodiment of the present invention where point aggregation is achieved in a multi-level referral system.

FIG. 4(a) is a flow chart illustrating one embodiment of the present invention with point aggregation in a multi-level referral system.

FIG. 4(b) is a flow chart illustrating one embodiment of the present invention with a two-level referral system with awarded points flowing only two levels up for referrals.

FIG. 5 is a flow chart illustrating one embodiment of the present invention where there are caps on the amount or value of points awarded to a member.

FIG. 6 is a flow chart illustrating various flows of consideration, in one embodiment of the present invention, which can be in the form of financial remuneration to the service provider system and financial institutions, and points to members.

FIG. 7 is illustrates schemas of tables in a relational database that can be utilized with the FIG. 1 embodiment of the present invention.

### DETAILED DESCRIPTION OF THE PREFERRED EMBODIMENTS

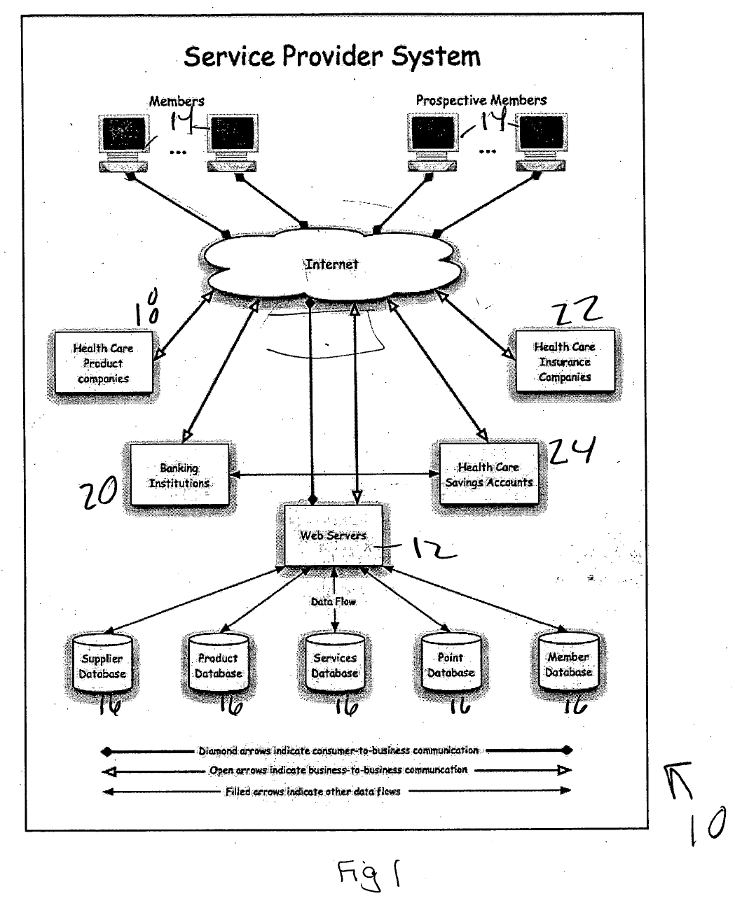

As illustrated in FIG. 1, one embodiment of the present invention is a system, and its methods of use, for selling health related products, services, health care insurance plans, and the like through the Internet. A service provider system 10 has one or more web servers 12. Service provider system 10 enrolls prospective members as members, collectively members 14, for the purpose of members purchasing health related products, services and health plans through service provider system 10. A product or service request message for a desired product or service is received from a member 14 through a customer interface. The product or service request message includes a product or service identifier.

Service provider system 10 can include a single database, multiple databases, a single database or multiple databases 16, are provided that include information relative to suppliers, products, services, points, members and the like.

Service provider system 10 transmits a request for the desired product or service request from one of its web servers 12 to a supplier of the desired product or service, generally denoted as 18. A determination is made, and then recorded in a computer memory of points awarded to a member for purchases made by the member itself through service provider system 10.

Service provider system 10 is linked with one or more financial institutions 20 for purposes of payment. Payment is made in a variety of different ways, including but not limited to credit/debit cards offered by service provider system 10, credit/debit cards from financial organizations that are part of service provider system 10 community, and the like. In one embodiment, service provider system 10 retains a portion of the purchase price of the product, service or health care insurance plan as its fee.

In one embodiment, service provider system 10 awards a debit and/or credit card to a new or existing member 14 for purchases made through service provider system 10. Service provider system 10 can also be linked to one or more health care providers 22, health care savings accounts, health care security savings accounts (as proposed under H.R. 2596) or similar approved insurance health accounts, collectively 26, and the like.

In one embodiment, points are awarded to members 14 for purchases made through service provider system 16. Points can be awarded to a member 14, in a multi-level implementation, for purchases, (i) made by a first member 14 itself through service provider system 10, (ii) made by members 14 who were referred to service provider system by the first member 14, and (iii) made by members 14 who were referred to service provider system 10 by members 14 in (ii).

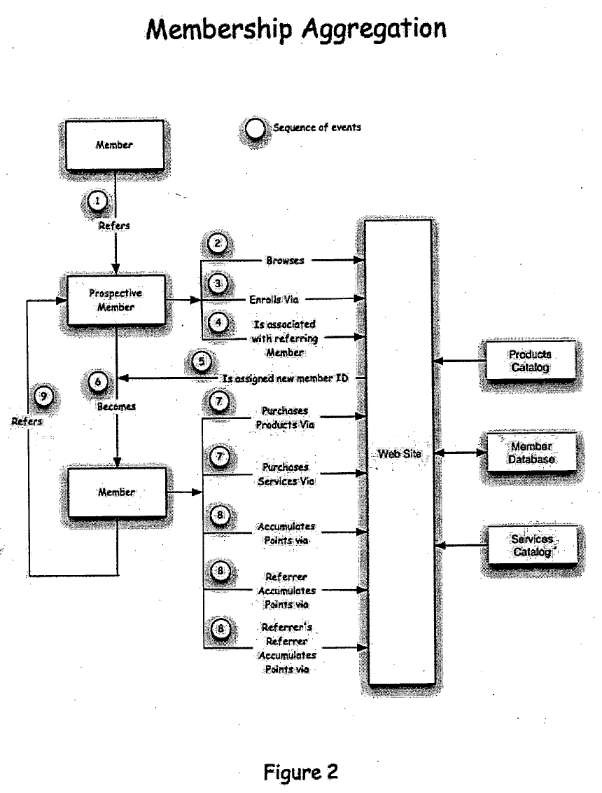

Referring to FIG. 2, the purchasing power of members 14 are aggregated in the community of service provider system 10. One member 14 can refer applicants to become members 14 of service provider system 14. An applicant decides to enroll in service provider system 10, at which time the new member 14 is then associated with his referred member 14. The new member 14 is assigned a member ID, and becomes a full member 14. As a full member 14, the new member 14 can purchase, products, services, health plans, and the like through service provider system 10. The new member 14 begins to accumulate points and can also refer new members 14 to service provider system 10, from which the new member 14 now receives points for purchases made by his referred members 14 who become registered with service provider system 10. The loop then continues, with new referrals of members 14, back up a chain to the original member 14 that initiated the referrals.

Members 14 can utilize the points for a variety of different applications, including but not limited to, (i) application to a health savings account or a similarly approved account, (ii) offset costs associated with a health savings account or a similarly approved account, (iii) application to a health savings security account or a similarly approved account, (iv) offset costs associated with a health savings security account or a similarly approved account, and the like.

Members can view listings of available products and services through a browsable catalog. A product database 16 provides a listing of different products including but not limited to, vitamins or nutritional supplements, energy/protein bars, health food products, weight loss products, non-prescription drugs, prescription drugs, contact lenses and associated supplies, dermatology/skin care products, oral care products, fitness products, fitness clubs, health books, health and_fitness magazines, health insurance, wellness insurance, disability insurance, dental insurance, pet insurance, allergy and asthma products, diabetes products addiction treatment and rehabilitation treatment centers, athletic clothing and gear, therapeutic and_chiropractic products, pet care and medication products, exercise equipment, and the like.

A service database 16 provides a listing of different services including but not limited to, services associated with health savings accounts, services associated with health savings security accounts or a similarly approved account, banking services, insurance services, services from a medical information websites, physician guides and hospital rating guides, preventative care and wellness services, nurse hotlines, health network charitable foundation services, preventative care and wellness services, and the like.

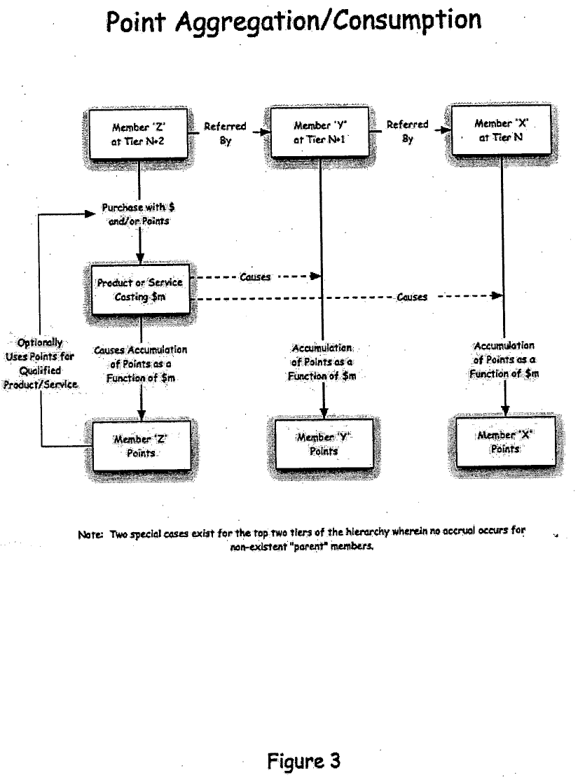

By way of illustration, in one embodiment of the present invention, as shown in FIG. 3, point aggregation can be achieved in a multi-level referral system. By way of illustration, a member “z” purchases a product, service of health care insurance plan through service provider system 10 for “m” dollars. This causes an accumulation of points for member z based on the m dollars. Member “y” also accumulates points based on the purchase of the product because member y referred member z to service provider system 10. The number of points awarded to members z and y can be the same or different. Member z can utilize points for all or a portion of the purchase price of the product if member z has pre-existing points at the time of the purchase of the product. Member “x” receives points as a function of the dollar amount m, because member x referred member y, who in turn referred member z. The points awarded are typically integral numbers of a percentage of the purchase price x.

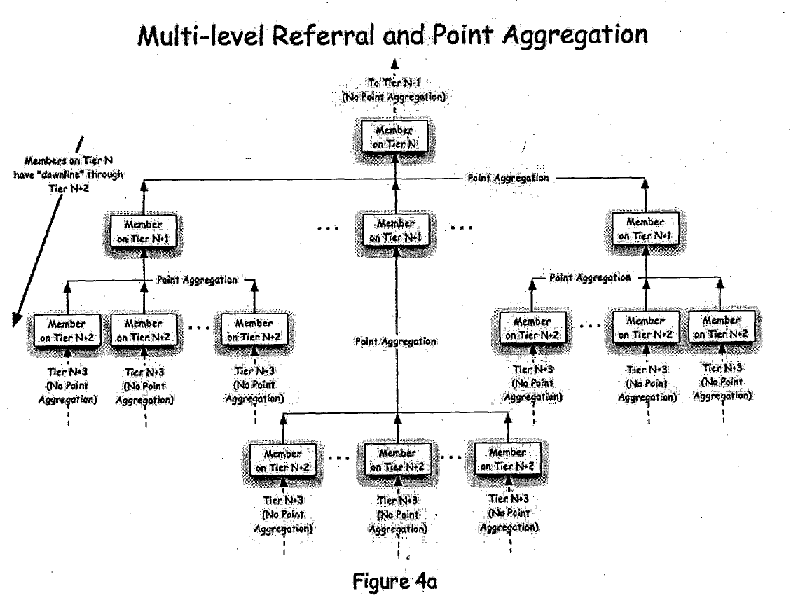

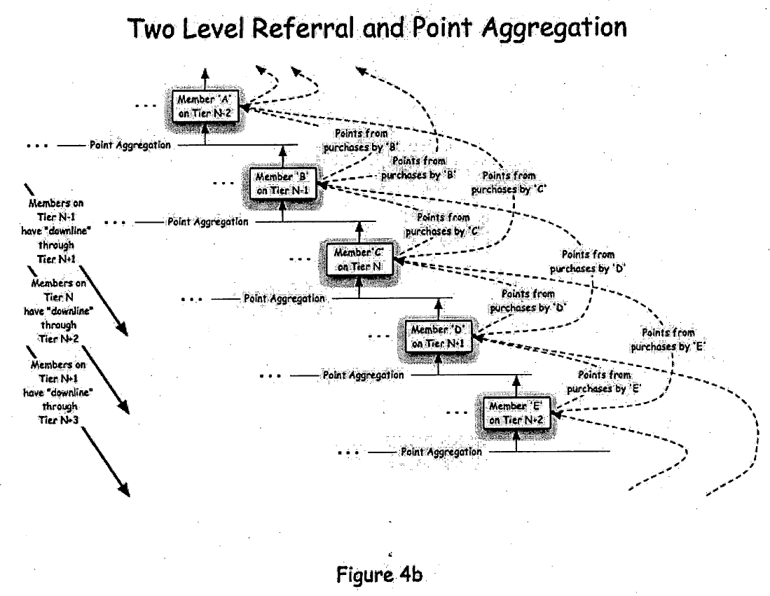

One example of point aggregation, is a multi-level referral system illustrated in FIG. 4(a). Once members 14 have enrolled in service provider system 10, the relationships of the members 14, for purposes of points, are based on a multi-level referral system where the award of points flows upwards to the referring members 14. It will be appreciated that the member 14 who makes the actual purchase also receives points. One, two or more levels of point aggregation for referrals can be utilized. A two-level referral embodiment, where points flow only two levels up for referrals, is illustrated in FIG. 4(b).

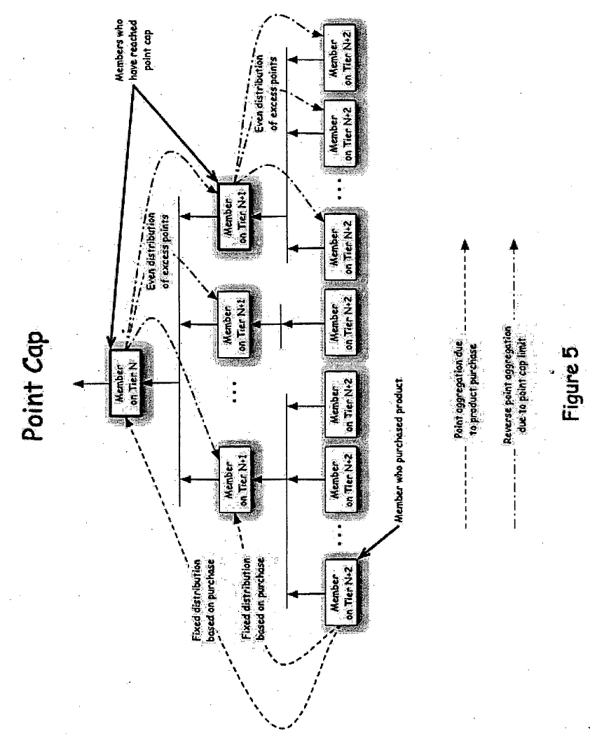

In various embodiments, service provider system 10 can place caps, or limits, on the number or value of points awarded to a member 14. FIG. 5 illustrates that a member 14 at a higher level has exceeded the points that he is allowed to aggregate for a selected period of time. These excess points can be awarded, (i) to those members 14 who are referrals and referrals of referrals of the member 14 who exceeded the cap, (ii) to other third party members 14 enrolled in service provider system 10, (iii) to charitable organizations in the community of service provider system 10, and (iv) the excess points can be lost relative to the exceeding member 14 but still remain in the community of service provider system 10 (for use by service provider system 10).

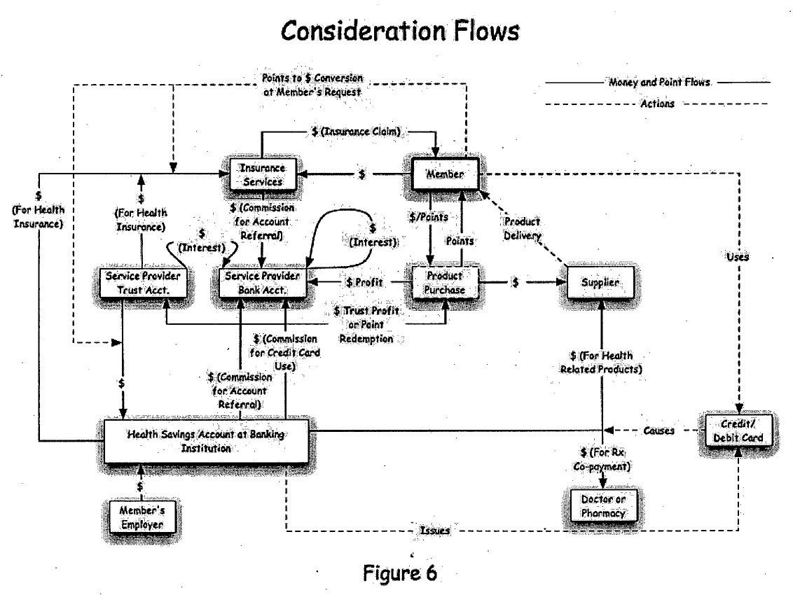

The various flows of consideration, which can be in the form of financial remuneration to service provider system 10 and financial institutions, and points to members 14, are shown in FIG. 6. A member 10 spends dollars and/or points for a product purchase. This event causes dollars to flow to the supplier of the product or service who ships the product or service to the purchaser. The product purchase creates a profit that is awarded to service provider system 10, which is forwarded to the financial account and/or trust account of service provider system. The dollars in the trust account directly correlate to the points awarded by service provider system 10, as well as the points aggregated and awarded to members 14 in the multi-level referral system.

A member can purchase a health care insurance plan, other health-related insurance through service provider system 10 at any time, even after his initial enrollment. A member can also utilize his points, and apply them to pay for all or a portion of his costs of a health savings account, health savings security account, or other similarly qualified/approved health accounts, even if the account was not acquired through the service provider system. Examples of health care insurance plans include but are not limited to, defined health care insurance plan where at least a portion of its costs are funded by tax free dollars and the like.

In one embodiment, the defined health care insurance plan is at least partially funded by an employer's contributions, and points can be used by the employee, if the employee is a member, through service provider system 10 to offset the employee's costs. At least a portion of the costs of a member's 10 health care insurance plan or other health-related insurance can be payable with points awarded by service provider system 10 to a member 14 for purchases made by that member 14 through service provider system 10. Points can be applied to the costs of a health care insurance plan or other heath related insurance plan in one year, and if not used in that year rolled over to costs for subsequent years. Members 14 can be initially enrolled in heath care plans and other types of health-related insurance plans outside of service provider system 10, and then use their purchases, through service provider system 10 in the form of points, to offset and pay for their associated costs and fees of the health care insurance plan and health related insurance that are not covered by their employers, and the like.

In one embodiment, at least a portion of the points awarded by service provider system 10 are treated as non-taxable income for federal income tax purposes. In another embodiment, at least a portion of the points awarded by service provider system 10 that are applied to a health care insurance plan through service provider system 10, including but not limited to heath savings accounts, health savings securities accounts or a similarly approved account, are treated as non-taxable income for federal income tax purposes at they time they are awarded or used.

In one embodiment, points awarded by service provider system 10, may have one or more of the following limitations on their use, (i) be transferable by a member 10 only to an exempt organization for use in fulfilling its exempt purpose, (ii) be not convertable to cash or a cash equivalent, (iii) have a limited life, (iv) have a lifetime that does not exceed than 24 months, (iv) be used as a discount on future purchases of products or services through service provider system 10 only by the member who earned them.

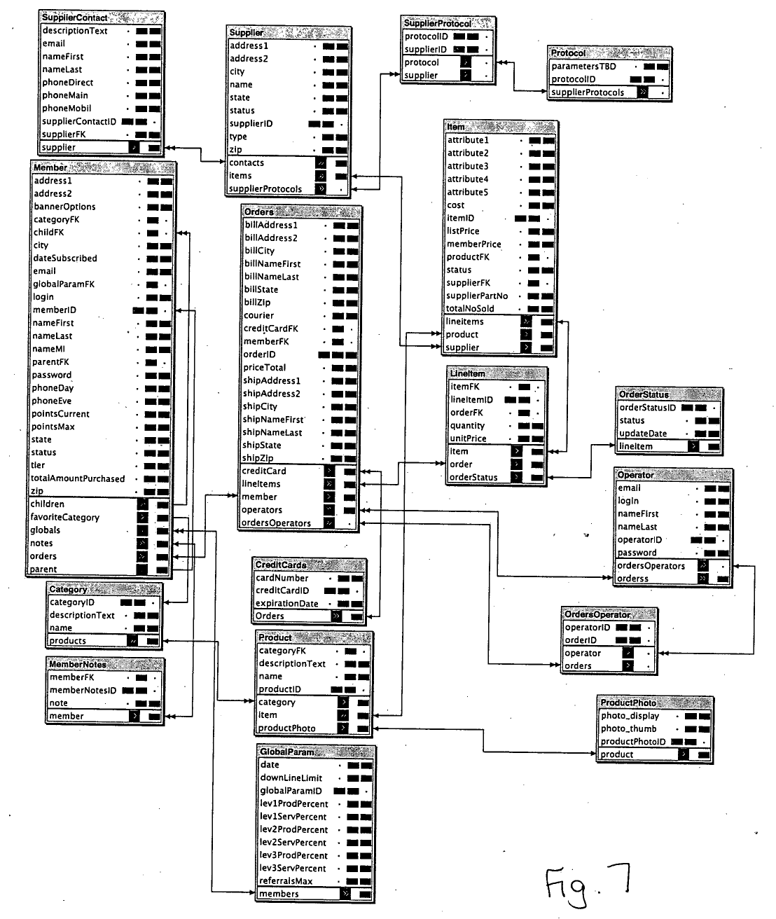

By way of illustration, and without limitation, schemas of tables in a relational database that can be utilized with the present invention are illustrated in FIG. 7. A single arrow indicates a to-one relationship, a double arrow indicates a to-many relationship. Each box is a table in the database. Each box has attributes (data fields) and relationships.

The foregoing description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

1. A method of selling a health related product or service via the Internet, comprising:
providing a service provider system with a web server that has a database, the service provider system having members that purchase health related products and services through the service provider system;
enrolling applicants in the service provider system as members;
recording within a computer memory points awarded to a member for purchases, (i) made by the member itself through the service provider system, (ii) made by members who were referred to the service provider system by the member, and (iii) made by members who were referred to the service provider system by members in (ii);
assigning a member identifier to each member and recording the member identifier in a computer memory;
receiving at the service provider system, from a member purchasing a product or service, a request message that contains a requested product or service item identifier and a member identifier; and
transmitting by the service provider system to a supplier of the requested product or service, a request for the product or service.

2. The method of claim 1, wherein at least a portion of the points are not treated as taxable income for federal income tax purposes at they time they are awarded or used.

3. The method of claim 1, wherein points awarded to a member have a cap in number or value.

4. The method of claim 1, wherein the number of points awarded to a member of purchases made under (ii) or (iii) is capped in number or value.

5. The method of claim 1, wherein the number points awarded from members under (ii) and (iii) for a member under (i) is capped in number of value.

6. The method of claim 1, wherein when the member purchasing the product is a member identified in (i) of claim 1, then the request message includes the member identifier of the member.

7. The method of claim 1, wherein when the member purchasing the product is a member identified in (ii) of claim 1, then the request message includes member identifiers of those members identified in (i) of claim 43.

8. The method of claim 1, wherein when the member purchasing the product is a member identified in (iii) of claim 1, then the request message includes member identifiers of those members identified in (ii) and (i) of claim 43.

9. The method of claim 1, wherein the points are awarded at least in part based on a selling price of the purchased product or service.

10. The method of claim 1, wherein the points are awarded electronically and stored in a database for use for subsequent purchases.

11. The method of claim 1, further comprising:
transmitting a business agreement which specifies the terms for referring customers to the service provider system.

12. The method of claim 1, wherein the service provider system includes a database, the database including information about health related health products and services, the database configured to track points awarded by the service provider system to its members for purchases made through the service provider system.

13. The method of claim 1, wherein the points are utilized by members for future purchases of products or services through the service provider system.

14. The method of claim 1, wherein at least a portion of the points are utilized by members for application to a health savings account or a similarly approved account.

15. The method of claim 1, wherein at least a portion of the points utilized by members for application to the health savings account or a similarly approved account are not treated as taxable income for federal income tax purposes at they time they are awarded or used.

16. The method of claim 1, wherein at least a portion of the points are utilized members to offset costs associated with a health savings account or a similarly approved account.

17. The method of claim 16, wherein at least a portion of the points utilized by members to offset costs associated with the health savings account or a similarly approved account are not treated as taxable income for federal income tax purposes at they time they are awarded or used.

18. The method of claim 1, wherein at least a portion of the points are utilized by members for application to a health savings security account or a similarly approved account.

19. The method of claim 18, wherein at least a portion of the points utilized by members for application to the health savings security account or a similarly approved account are not treated as taxable income for federal income tax purposes at they time they are awarded or used.

20. The method of claim 1, wherein at least a portion of the points are utilized by members to offset costs associated with a health savings security account or a similarly approved account.

21. The method of claim 20, wherein at least a portion of the points utilized by members to offset costs associated with the health savings security account or a similarly approved account are not treated as taxable income for federal income tax purposes at they time they are awarded or used.

22. The method of claim 1, wherein the points are_transferable only by a member to an exempt organization for use in fulfilling its exempt purpose.

23. The method of claim 1, wherein the points can not be converted to cash or a cash equivalent.

24. The method of claim 1, wherein the points have a limited life.

25. The method of claim 1, wherein the points have a life of no more than 24 months.

26. The method of claim 1, wherein the points can only be used as a discount on future purchases of products or services through the service provider system by the member who earned them.

27. The method of claim 1, wherein the products are selected from vitamins or nutritional supplements, energy/protein bars, health food products, weight loss products, non-prescription drugs, prescription drugs, contact lenses and associated supplies, dermatology/skin care products, oral care products, fitness products, fitness clubs, health books, health and_fitness magazines, health insurance, wellness insurance, disability insurance, dental insurance, pet insurance, allergy and asthma products, diabetes products addiction treatment and rehabilitation treatment centers, athletic clothing and gear, therapeutic and_chiropractic products, pet care and medication products, and exercise equipment.

28. The method of claim 1, wherein the services are health savings accounts or a similarly approved account.

29. The method of claim 1, wherein the services are health savings security accounts or a similarly approved account.

30. The method of claim 1, wherein the services are banking services.

31. The method of claim 1, wherein the services are insurance services.

32. The method of claim 1, wherein the services from a medical information website.

33. The method of claim 1, wherein the services are physician and hospital rating guides.

34. The method of claim 1, wherein the services are preventative car and/wellness services.

35. The method of claim 1, wherein the services are a nurse hotline.

36. The method of claim 1, wherein the services are health network charitable foundation services.

37. The method of claim 1, wherein the service provider system enables a member to transfer points to a charitable fund.

38. The method of claim 1, wherein the service provider system enables a member to transfer points to another member.

39. The method of claim 1, wherein the service provider system includes a browsable catalog of products and services.

40. The method of claim 1, further comprising:
assigning to a member a debit or credit card a debit or credit cards for selected members for purchases through the service provider system.

41. The method of claim 40, wherein the service provider system receives a portion of a debit or credit card_fee associated with using the debit or_credit card for purchases made through the service provider system.

42. A method of brokering health care insurance plan via the Internet, comprising:
providing a service provider system with a web server that has a health care insurance plan database, the service provider system having members that purchase health care insurance plan through the service provider system;
enrolling applicants in the service provider system as members;
assigning to a member a member identifier that is stored in a computer memory;
recording within a computer memory points awarded to a member for purchases, (i) made by the member itself through the service provider system, (ii) made by members who were referred to the service provider system by the member, and (iii) made by members who were referred to the service provider system by members in (ii), wherein a member can utilize points awarded under (i) to offset the costs associated with a health care insurance plan through the service provider system;
receiving at the service provider system, from a member purchasing a health care insurance plan, a request message that contains a requested health care insurance plan identifier and a purchasing member identifier; and
transmitting by the service provider system to a supplier of the health care insurance plan, a request for approval of the member for the health care insurance plan.

43. The method of claim 42, wherein at least a portion of the points are not treated as taxable income for federal income tax purposes at they time they are awarded or used.

44. A method of brokering health care insurance plan via the Internet, comprising:
providing a service provider system with a web server that has a database of health care products, services and health care insurance plan database, the service provider system having members that purchase health care products, services and plans through the service provider system, at least a portion of the health care insurance plan being defined health care insurance plan that are least partially funded by tax-free dollars;
enrolling applicants in the'service provider system as members;
assigning to a member a member identifier that is stored in a computer memory;
receiving from a member at the service provider system after the member has become enrolled in the service provider system a request for information on one or more health care insurance plan;
selecting a health care insurance plan by the member through the service provider system; and
transmitting by the service provider system to a supplier of the health care insurance plan, a request for approval of the member for the health care insurance plan selected by the member.

45. The method of claim 44, wherein at least a portion of the defined health care insurance plan are funded by employer's contributions.

46. The method of claim 44, wherein at least a portion of the defined health care insurance plan are funded by points awarded by the service provider system to a member for purchases made by that member through the service provider system.

47. The method of claim 44, wherein at least a portion of health care insurance plan have costs, at least a portion of the costs being payable with points awarded by the service provider system to a member for purchases made by that member through the service provider system.

48. The method of claim 47, wherein points applied to the costs of a health care insurance plan in one year that are not used in that one year can be rolled over for application of costs of the health care insurance plan in subsequent years.

49. The method of claim 87.1, further comprising:
recording within a computer memory points awarded to members for purchases, (i) made by the member itself through the service provider system, (ii) made by members who were referred to the service provider system by the member, and (iii) made by members who were referred to the service provider system by members in (ii).

50. The method of claim 49, wherein at least a portion of the points are not treated as taxable income for federal income tax purposes at they time they are awarded or used.

51. A method of brokering health care insurance plan via the Internet, comprising:
providing a service provider system with a web server that has a database of health care products, services and health care insurance plan database, the service provider system having members that purchase health care products, services and plans through the service provider system;
enrolling applicants in the service provider system as members;
receiving from members at the service provider system requests for information on one or more health care insurance plan;
selecting health care insurance plan by members through the service provider system, at least a portion of the health care insurance plan being defined health care insurance plan that are least partially funded by tax-free dollars;
aggregating a plurality of different purchases by members of health care insurance plans to effect a decreased cost of at least a portion of the health care insurance plan; and
transmitting by the service provider system to suppliers of the health care insurance plan requests for approval of the members for the health care insurance plan selected by the members.

52. The method of claim 51, wherein at least a portion of the defined health care insurance plan are funded by employer's contributions.

53. The method of claim 51, wherein at least a portion of the defined health care insurance plan are funded by points awarded by the service provider system to a member for purchases made by that member through the service provider system.

54. The method of claim 51, wherein at least a portion of health care insurance plan have co-payments payable by points awarded by the service provider system to a member for purchases made that member through the service provider system.

55. The method of claim 51, further comprising:
recording within a computer memory points awarded to members for purchases, (i) made by the member itself through the service provider system, (ii) made by members who were referred to the service provider system by the member, and (iii) made by members who were referred to the service provider system by members in (ii).

56. The method of claim 55, wherein at least a portion of the points are not treated as taxable income for federal income tax purposes at they time they are awarded or used.

57. A method of brokering health care insurance plan via the Internet, comprising:
providing a service provider system with a web server that has a database of health care products, services and a health care insurance plan database, the service provider system having members that purchase health care products, services and plans as a community through the service provider system;
enrolling applicants in the service provider system as members;
assigning to a member a member identifier that is stored in a computer memory;
receiving from a member at the service provider system after the member has become enrolled in the service provider system a request for information on one or more health care insurance plan;
selecting a health care insurance plan by the member through the service provider system;
transmitting by the service provider system to a supplier of the health care insurance plan, a request for approval of the member for the health care insurance plan selected by the member; and
purchasing the health care insurance plan through the service provider system.

58. A method of selling a product or service via the Internet, comprising:
providing a service provider system that includes a web server and a computer memory, the service provider system having members that purchase health related products and services through the service provider system;
enrolling applicants in the service provider system as members; and
recording within the computer memory points awarded to a member 1 for the purchase of products or services from a third party provider outside of the service provider system, by member 1 itself or its affiliated members, the affiliated members selected from at least, (i) one or more members 2 referred to the service provider system by member 1, and (ii) members 3 who were referred to the service provider system by members 2.

59. A method of selling a product or service via the Internet, comprising:
providing a service provider system that includes a web server and a computer memory, the service provider system having members that purchase health related products and services through the service provider system;
enrolling applicants in the service provider system as members;
awarding a service provide system credit or debit card to members;
recording within the computer memory points awarded to a member 1 for the purchase of products or services from a third party provider outside of the service provider system using the surface provider credit or credit card, by member 1 itself or its affiliated members, the affiliated members selected from at least, (i) one or more members 2 referred to the service provider system by member 1, and (ii) members 3 who were referred to the service provider system by members 2.

60. A method of selling a health related product or service via the Internet, comprising:
providing a service provider system that includes a web server and a computer memory, the service provider system having members that purchase health related products and services through the service provider system;
enrolling applicants in the service provider system as members; and
recording within the computer memory points awarded to a member 1 for health related product or service purchases made by member 1 itself or its affiliated members, the affiliated members selected from at least, (i) one or more members 2 referred to the service provider system by the member 1, and (ii) members 3 who were referred to the service provider system by members 2, for a purchase of a product or service by a member from a third party other than the service provider system, wherein at a time of enrollment each member elects to take all of the points or gift down at least a portion of the points to affiliated members.

61. The method of claim 60, wherein the credit or debit card is a third party credit or debit card.

62. The method of claim 60, wherein the credit or debit card is a service provider system debit or credit card.

63. The method of claim 60, wherein the health care product or service is selected from a health savings account, a health savings security account or a similarly approved account.

64. The method of claim 63, wherein at least a portion of the points utilized by members for purchase of, or used to offset the costs to purchase, the health savings account, the health savings security account or the similarly approved account, are not treated as taxable income for federal income tax purposes at they time they are awarded or used.

65. The method of claim 60, wherein points awarded to a member have a cap in number or value.

66. The method of claim 60, wherein the number of points awarded to a member of purchases made under (ii) or (iii) is capped in number or value.

67. The method of claim 60, wherein the number points awarded from members under (ii) and (iii) for a member under (i) is capped in number of value.

68. The method of claim 60, wherein the products are selected from vitamins or nutritional supplements, energy/protein bars, health food products, weight loss products, non-prescription drugs, prescription drugs, contact lenses and associated supplies, dermatology/skin care products, oral care products, fitness products, fitness clubs, health books, health and_fitness magazines, health insurance, wellness insurance, disability insurance, dental insurance, pet insurance, allergy and asthma products, diabetes products addiction treatment and rehabilitation treatment centers, athletic clothing and gear, therapeutic and_chiropractic products, pet care and medication products, and exercise equipment.

69. The method of claim 60 wherein the service provider system receives a portion of a debit or credit card fee associated with using the debit or_credit card.

70. The method of claim 60, wherein the service provider system includes logic that provides compliance with the Privacy Rule of the Health Insurance Portability and Accountability Act of 1996 for members that purchase, or offset costs to purchase for, the health care product or service through the service provider system.

71. The method of claim 70, wherein the logic limits access to patient health information in compliance with the Privacy Rule of the Health Insurance Portability and Accountability Act of 1996.

72. The method of claim 70, wherein the service provider system provides an authorization for disclosure of health information of a member that uses the points for a the health care product or service is selected from a health savings account, a health savings security account or a similarly approved account.

73. The method of claim 70, wherein the service provider system transmits protected health information (PHI) HIPPA Privacy Rule in compliance with the HIPPA Privacy Rule.

74. The method of claim 74, wherein the authorization contains a description of the PHI of an U/D.

75. The method of claim 74, wherein the authorization is written.

76. The method of claim 74, wherein the authorization identifies the person authorized to make the requested U/D

77. The method of claim 74, wherein the authorization describes the purpose of the U/D.

78. The method of claim 74, wherein the authorization contains a statement of the member's right to revoke the authorization,

79. The method of claim 74, wherein the written includes a signature of the member and the date the authorization was signed.

80. The method of claim 79, wherein the signature is an electronic signature.

81. The method of claim 60, wherein the service provider system includes a HIPPA Compliance Committee.

82. The method of claim 60, further comprising:
advising members of rights to privacy under HIPPA Privacy Rule.

83. The method of claim 60, further comprising:
preparing an NPP in compliance with the HIPPA Privacy Rule.

84. The method of claim 60, wherein the service provider system grants exclusivity for selected products or services to selected providers.

85. The method of claim 60, wherein at the time a member joins the service provider system, the member makes an election to keep all points awarded for purchases under (i), or elects that at least a portion of points awarded for purchases under (i) are awarded to members in one or both of (ii) and (iii).

86. The method of claim 85, wherein the at least a portion of points awarded for purchases under (i) that are awarded to members in at least (ii) or (iii) are gifted.

87. The method of claim 85, wherein an amount of the at least a portion of points awarded for purchases under (i) that are awarded to members in at least (ii) or (iii) is determined by the service provider system.

88. The method of claim 60, wherein the amount of points awarded to a member of a related member group is insufficient points to required filling of a 1099 form with the IRS.

89. The method of claim 60, wherein an amount of points gifted down to affiliated members is determined by member 1.

90. The method of claim 60, wherein an amount of points gifted down to affiliated members is determined by the service provider system.

91. The method of claim 60, wherein points gifted down to affiliated members are tax free.

92. A method of selling a health related product or service via the Internet, comprising:
providing a service provider system that includes a web server and a computer memory, the service provider system having members that purchase health related products and services through the service provider system;
enrolling applicants in the service provider system as members; and
recording within the computer memory points awarded to a member 1 for health related product or service purchases made by member 1 itself or its affiliated members, the affiliated members selected from at least, (i) one or more members 2 referred to the service provider system by the member 1, and (ii) members 3 who were referred to the service provider system by members 2, the service provider system awarding points to members 2 and/or 3 when a purchasing goal set by the service provider system is reached by the affiliated members.

93. A method of selling a product or service provided by a provider of the product or
service via the Internet, comprising:
providing a service provider system that includes a web server and a computer memory, the service provider system having members that purchase health related products and services through the service provider system;
enrolling applicants in the service provider system as members, approving providers by the service provider system to sell products or services through the service provider system;
recording within the computer memory points awarded to a member for health related product or service purchases, (i) made by the member itself, (ii) made by members who were referred to the service provider system by the member, and (iii) made by members who were referred to the service provider system by members in (ii), members 2 and 3 being affiliated members; and
utilizing at least a portion of the points for purchase of, or offset the costs to purchase, a health care product or service through the service provider system while remaining in compliance with the HIPPA Privacy Rule.

94. A method of selling a product or service provided by a provider of the product or service via the Internet, comprising:
providing a service provider system that includes a web server and a computer memory, the service provider system having members that purchase health related products and services through the service provider system;
enrolling applicants in the service provider system as members, approving providers by the service provider system to sell products or services through the service provider system;
recording within the computer memory points awarded to a member for health related product or service purchases, (i) made by the member itself, (ii) made by members who were referred to the service provider system by the member, and (iii) made by members who were referred to the service provider system by members in (ii), members 2 and 3 being affiliated members;
making application for enrollment in a health care plan through the service provider system by a member;
advising the member applying for the health care plan of its rights under the HIPPA Privacy Rule; and
utilizing at least a portion of the points for purchase of, or offset the costs to purchase, the health care plan.

95. A method of selling a product or service provided by a provider of the product or service via the Internet, comprising:
providing a service provider system that includes a web server and a computer memory, the service provider system having members that purchase health related products and services through the service provider system;
enrolling applicants in the service provider system as members, approving providers by the service provider system to sell products or services through the service provider system;
recording within the computer memory points awarded to a member for health related product or service purchases, (i) made by the member itself, (ii) made by members who were referred to the service provider system by the member, and (iii) made by members who were referred to the service provider system by members in (ii), members 2 and 3 being affiliated members;
making application for enrollment in a health care plan through the service provider system by a member through an enrollment form that is in compliance with the HIPPA Privacy Rule; and
utilizing at least a portion of the points for purchase of, or offset the costs to purchase, the health care plan.

96. A method of selling a product or service via the Internet, comprising:
providing a service provider system that includes a web server and a computer memory, the service provider system having members that purchase health related products and services through the service provider system;
enrolling applicants in the service provider system as members; and
recording within the computer memory points awarded to a member 1 for the purchase of products or services from a third party provider outside of the service provider system, by member 1 itself or its affiliated members, the affiliated members selected from at least, (i) one or more members 2 referred to the service provider system by member 1, and (ii) members 3 who were referred to the service provider system by members 2, wherein at a time of enrollment each member elects to take all of the points or gift down at least a portion of the points to affiliated members.

97. A method of selling a product or service via the Internet, comprising:
providing a service provider system that includes a web server and a computer memory, the service provider system having members that purchase health related products and services through the service provider system;
enrolling applicants in the service provider system as members; and
recording within the computer memory points awarded to a member 1 for the purchase of products or services from a third party provider outside of the service provider system, by member 1 itself or its affiliated members, the affiliated members selected from at least, (i) one or more members 2 referred to the service provider system by member 1, and (ii) members 3 who were referred to the service provider system by members 2.
